(19) United States
(12) Patent Application Publication
(10) Pub. No.: US 2026/0146711 A1
(43) Pub. Date: May 28, 2026

(54) OUTER PROTECTION SYSTEM FOR LIQUID GAS STORAGE TANK, LIQUID GAS STORAGE TANK COMPRISING THE SAME, AND METHOD FOR FORMING THE OUTER PROTECTION SYSTEM

(71) Applicant: DONGSUNG FINETEC CO., LTD., Anseong-si (KR)

(72) Inventors: Kab-Soo KIM, Anseong-si (KR); Sung-Joong KIM, Anseong-si (KR); Woo-Bin SIM, Anseong-si (KR); Byeong-Jun CHOI, Anseong-si (KR)

(21) Appl. No.: 19/402,230

(22) Filed: Nov. 26, 2025

(30) Foreign Application Priority Data
Nov. 27, 2024 (KR) 10-2024-0172896

(51) Int. Cl. F17C 1/12; F17C 1/02

(52) U.S. Cl. CPC F17C 1/12; F17C 1/02; F17C 2203/0634

(57) ABSTRACT

The present invention relates to an outer protection system for a liquefied gas storage tank, a liquefied gas storage tank comprising the same, and a method for forming the outer protection system for a liquefied gas storage tank. The outer protection system for a liquefied gas storage tank includes: an insulation part arranged on an outer surface of a storage tank body accommodating liquefied gas therein; and a protection part arranged on an outer surface of the insulation part; wherein the protection part includes: a first urea coating layer arranged on the insulation part; a second urea coating layer arranged on the first urea coating layer; and a reinforcement layer arranged in a partial region between the first urea coating layer and the second urea coating layer, the reinforcement layer including a plurality of reinforcements spaced apart from each other.

### CROSS-REFERENCE TO RELATED APPLICATION

This application claims priority under 35 U.S.C. § 119 to Korean Patent Application No. 10-2024-0172896, filed on Nov. 27, 2024, in the Korean Intellectual Property Office (KIPO), the disclosure of which is incorporated by reference herein in its entirety.

### TECHNICAL FIELD

The present invention relates to an outer protection system for a liquefied gas storage tank, a liquefied gas storage tank comprising the same, and a method for forming the outer protection system for the liquefied gas storage tank.

### BACKGROUND ART

Liquefied gases, such as Liquefied Natural Gas (LNG), Liquefied Petroleum Gas (LPG), and Liquefied Ethylene Gas, are obtained by cooling natural gas or petroleum gas to a cryogenic temperature (approximately −163° C. in the case of LNG). Since their volume is significantly reduced compared to when they are in a gaseous state, they are highly suitable for storage and transportation.

Such liquefied gases are stored and transported by storage tanks. However, when storing and transporting liquefied gas in a storage tank, there is a problem in that the liquefied gas vaporizes due to external heat, thereby increasing the internal pressure of the storage tank.

Accordingly, in the prior art, for thermal insulation of a liquefied-gas storage tank, polyurethane foam has been used either by attaching it to the tank surface in panel form or by spraying it to form an insulation layer (e.g., Korean Patent Publication No. 10-0166608 B1). However, when storing liquefied gas, which is a cryogenic material, in a storage tank, thermal stress may occur at the interface between the insulation layer and the storage tank, which can damage the insulation layer having relatively weak rigidity. Also, when liquefied gas is injected into or discharged from the storage tank, the internal temperature of the storage tank changes. Furthermore, since a ship equipped with the storage tank operates from the polar regions to the equator, the external temperature variation is large. Due to such temperature changes, the insulation layer itself may contract or expand, or the insulation layer may be damaged.

To solve these problems, conventionally, a system has been configured to protect the exterior of the storage tank by forming a protective layer made of a high-strength FRP material or urea coating on the insulation layer. However, due to the temperature influence of the cryogenic liquefied gas stored inside the tank, deformations such as contraction and expansion occurred in the outer protection system. In this case, the insulation layer may be delaminated from the tank surface, or the insulation layer and the protective layer within the outer protection system may be separated from each other, and cracks may occur in the insulation layer or the protective layer, resulting in deterioration of the insulation effect. Moreover, when there is a temperature change in the storage tank, a problem occurred in that the insulation layer or the protective layer was damaged or deformed due to the difference in the coefficient of thermal expansion between the insulation layer and the protective layer within the outer protection system. Furthermore, since the urea coating conventionally used as a conventional protective layer is weak against external forces, the urea coating is applied in locations not exposed to the outside air.

Accordingly, there is a need to develop a new outer protection system capable of protecting the liquefied gas storage tank from external environments and impacts, as well as from temperature changes.

### SUMMARY

An object of the present invention is to provide an outer protection system for a liquefied gas storage tank and a method for forming the same, which can stably protect the liquefied gas storage tank in physical, chemical, and environmental aspects.

Another object of the present invention is to provide a liquefied gas storage tank comprising the aforementioned outer protection system for a liquefied gas storage tank.

To achieve the above objects, the present invention provides an outer protection system for a liquefied gas storage tank, comprising:
an insulation part disposed on an outer surface of a storage tank body accommodating liquefied gas therein; and
a protection part disposed on an outer surface of the insulating part;
wherein
the protection part includes:
a first urea coating layer disposed on the insulation part;
a second urea coating layer disposed on the first urea coating layer; and
a reinforcement layer disposed in a partial region between the first urea coating layer and the second urea coating layer, the reinforcement layer including a plurality of reinforcements spaced apart from each other.

According to an embodiment of the present invention, the reinforcement layer may be disposed only in a region between an outer surface of the first urea coating layer 121 corresponding to an upper region of the storage tank body and an inner surface of the second urea coating layer 123.

According to an embodiment of the present invention, the reinforcement may include a rubber-containing composite sheet.

According to another embodiment of the present invention, the rubber-containing composite sheet may be a composite sheet including butyl rubber; and a fiber sheet or a metal sheet.

According to yet another embodiment of the present invention, the protection part may further include a UV blocking layer disposed on the second urea coating layer.

According to yet another embodiment of the present invention, the system may further include drain paths respectively disposed between a lower inner surface of each reinforcement 122a and a corresponding outer surface of the first urea coating layer 121.

In addition, the present invention provides a liquefied gas storage tank comprising a storage tank body accommodating liquefied gas; and the outer protection system for a liquefied gas storage tank, which is disposed on the outer surface of the storage tank body.

Furthermore, the present invention provides a method for forming an outer protection system for a liquefied gas storage tank, the method comprising: a step of forming an insulation part by spraying an insulation material on an outer surface of a storage tank body accommodating liquefied gas; a step of forming a first urea coating layer by spraying a first urea coating composition on the outer surface of the insulation part; a step of disposing a reinforcement layer by arranging a plurality of reinforcements spaced apart from each other on a part of an outer surface of the first urea coating layer; and a step of forming a second urea coating layer by spraying a second urea coating composition onto the outer surface of the first urea coating layer where the reinforcement layer is not formed and the outer surface of the reinforcement layer.

According to an embodiment of the present invention, the method may further include a step of forming a UV blocking layer on the second urea coating layer using a UV blocking coating composition.

According to another embodiment of the present invention, before the step of forming the reinforcement layer, the method may further include a step of disposing drain paths respectively on the outer surface of the first urea coating layer corresponding to a lower portion of each reinforcement.

In the present invention, the protection part formed on the insulation part includes flexible urea coating layers and a reinforcement layer interposed therebetween, thereby minimizing the occurrence of cracks due to contraction and expansion of the cryogenic tank, absorbing displacement according to temperature changes of the storage tank, and resolving potential failure problems.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 is a diagram schematically illustrating an outer protection system for a liquefied gas storage tank according to an embodiment of the present invention.

FIG. 2 is an enlarged cross-sectional view of part A of FIG. 1.

FIG. 3 is an enlarged cross-sectional view of part B of FIG. 1.

FIG. 4 is a top view showing a plurality of reinforcements spaced apart from each other in an outer protection system for a liquefied gas storage tank according to an embodiment of the present invention.

FIG. 5 is a side view showing a plurality of reinforcements spaced apart from each other in an outer protection system for a liquefied gas storage tank according to an embodiment of the present invention.

FIG. 6 is a flowchart showing a method for forming an outer protection system for a liquefied gas storage tank according to the present invention.

FIG. 7 is a photograph showing the process of forming a drain path when forming an outer protection system for a liquefied gas storage tank according to the present invention.

FIG. 8 is a drawing showing a plurality of reinforcements spaced apart from each other when forming an outer protection system of a liquefied gas storage tank of Embodiment 1.

FIG. 9 is a drawing showing a plurality of reinforcements spaced apart from each other when forming an outer protection system of a liquefied gas storage tank of Embodiment 2.

FIG. 10 shows the results of analyzing the thermal structure of the liquefied gas storage tanks of Embodiments 1 and 2.

### REFERENCE NUMERALS

| | |
|---|---|
| Storage Tank: T, | External Protection System: 100, |
| Insulation Part: 110, | Protection Part: 120, |
| First Protection Part: 120A, | Second Protection Part: 120B |
| First Urea Coating Layer: 121, | Reinforcement Layer: 122, |
| Second Urea Coating Layer: 123, | Drain Path: 130 |

### DETAILED DESCRIPTION

Hereinafter, preferred embodiments of the present invention will be described in detail with reference to the accompanying drawings. The embodiments of the present invention are provided to fully explain the present invention to those skilled in the art, and the following embodiments may be modified in various other forms, without the scope of the present invention being limited thereto. Throughout this specification, the same reference numerals refer to the same elements.

Unless otherwise defined, all terms (including technical and scientific terms) used herein may be used in a meaning that can be commonly understood by one of ordinary skill in the art to which the present invention belongs. Also, terms defined in commonly used dictionaries are not to be interpreted ideally or excessively unless explicitly defined.

In addition, the size and thickness of each component shown in the drawings are arbitrarily shown for convenience of explanation, and the present invention is not necessarily limited to what is shown. In the drawings, the thicknesses of layers and regions are exaggerated to clearly show multiple layers and regions. In the drawings, for convenience of explanation, the thicknesses of some layers and regions are exaggerated.

Further, throughout this specification, when a part is stated to “comprise” a component, this means that it may further include other components and does not exclude other components, unless otherwise stated.

Additionally, throughout the specification, “on” means not only being located above or below the target part, but also including cases where there is another part in between, and does not necessarily mean being located above with respect to the direction of gravity.

In addition, the terms “first,” “second,” and the like in this specification are not used to indicate any order or importance, but are used merely to distinguish components from each other.

In addition, in the present specification, “liquefied gas” may include all gaseous fuels that are generally stored in a liquefied state, such as LNG (Liquefied Natural Gas) at a cryogenic temperature (about −163° C.), as well as LPG (Liquefied Petroleum Gas) or Liquefied Ethylene Gas, and liquefied gas may mean not only liquefied gas in a liquid state but also vaporized liquefied gas.

### <Outer Protection System for a Liquefied Gas Storage Tank and Method for Forming the Same>

The present invention relates to an external protection system for a liquefied-gas storage tank configured to ensure the thermal insulation performance and related characteristics of a storage tank capable of storing and transporting liquefied gas therein, and can be applied to an independent liquefied-gas storage tank that is fabricated separately from the hull structure and mounted on the hull. Hereinafter, an example of the application of the outer protection system of the present invention to an independent-type liquefied gas storage tank is described.

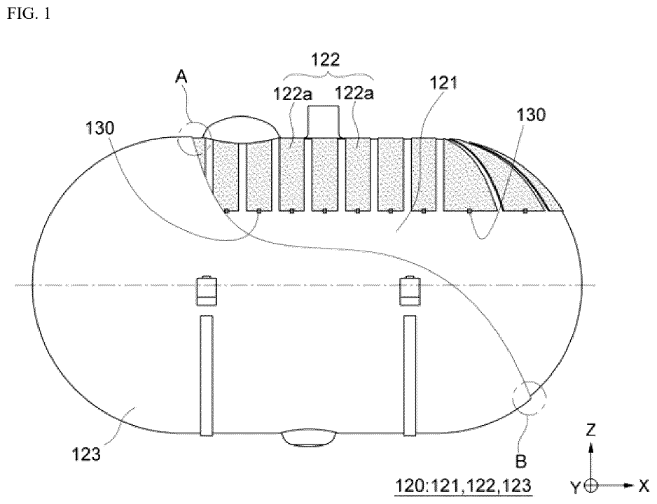

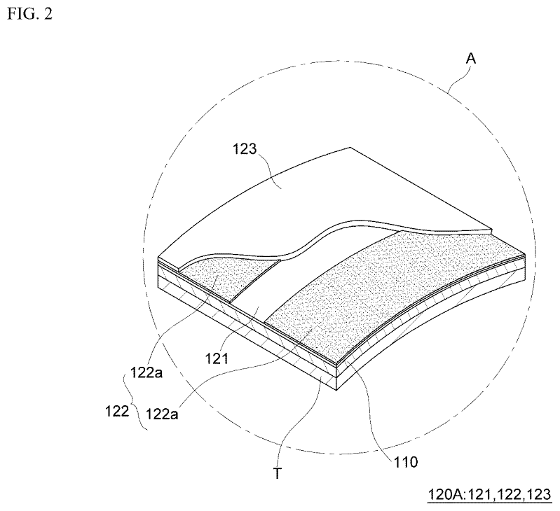

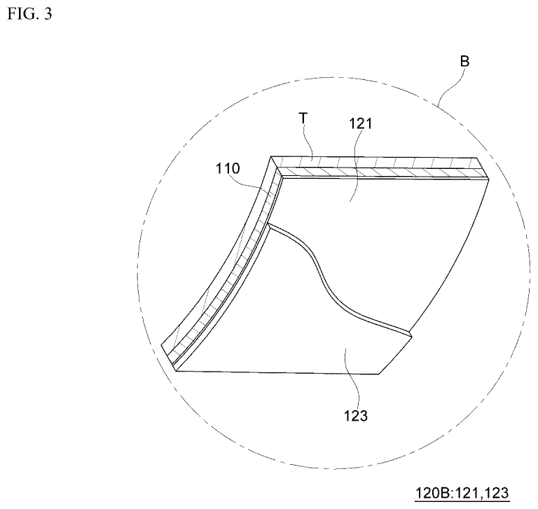

FIG. 1 is a schematic drawing of an outer protection system for a liquefied gas storage tank according to one embodiment, FIG. 2 is an enlarged cross-sectional view of part A of FIG. 1, and FIG. 3 is an enlarged cross-sectional view of part B of FIG. 1.

As illustrated in FIG. 1, an outer protection system 100 for a liquefied-gas storage tank according to an embodiment of the present invention is designed to protect the exterior of the liquefied-gas storage tank and to ensure the insulation performance of the storage tank. The system includes an insulation part 110 disposed on the outer surface of a storage-tank body T that accommodates liquefied gas; and a protection part 120 disposed on the outer surface of the insulation part 110, wherein the protection part 120 includes: a first urea coating layer 121 disposed on the insulation part 110; a second urea coating layer 123 disposed on the first urea coating layer 121; and a reinforcement layer 122 disposed in a partial region between the first urea coating layer 121 and the second urea coating layer 123, the reinforcement layer 122 including a plurality of reinforcements 122a, 122b spaced apart from each other.

Hereinafter, with reference to FIGS. 1 to 3, an outer protection system 100 for a liquefied gas storage tank according to one embodiment of the present invention will be described.

### (a) Insulation Part 110

In the present invention, the insulation part 110 is formed by spraying or attaching an insulation material on the outer surface of the tank body T, insulates the tank T from external heat intrusion, and prevents the liquefied gas accommodated inside from vaporizing.

The insulation material usable in the present invention is not particularly limited as long as it is known in the art, and may be, for example, polyurethane foam (PU foam) or a composition forming the same.

### (b) Protection Part 120

In the present invention, the protection part 120 is disposed on the outer surface of the aforementioned insulation part 110, as shown in FIG. 1. The protection part 120 can block foreign substances such as moisture that may enter from the outside and prevent damage to the insulation part. In particular, in a cryogenic environment, the protection part 120 can prevent the insulation part 110 from being damaged or cracked due to an increase in pressure inside the tank caused by a leak of liquefied gas or due to external impacts. Additionally, the protection part 120 can prevent displacement due to temperature changes in the storage tank.

The protection part 120 includes two urea coating layers 121, 123 arranged opposite each other and a reinforcement layer 122 disposed in a partial region between the urea coating layers 121, 123.

The first urea coating layer 121 is disposed on the outer surface of the insulation part 110, and has excellent adhesion to the insulation part 110 as an adherend, and also has excellent elasticity, so that the insulation part 110 can be prevented from being damaged when the tank body T contracts or expands.

The first urea coating layer 121 may be formed by directly spraying the first urea coating composition on the outer surface of the insulation part, but is not limited thereto. At this time, the first urea coating composition is not particularly limited as long as it is generally known in the art.

The second urea coating layer 123 is disposed opposite to the first urea coating layer 121, and is disposed on the outer surface of the first urea coating layer 121 where the reinforcement layer 122 is not formed and on the outer surface of the reinforcement layer 122. The second urea coating layer 123 has excellent waterproofing, heat resistance, corrosion resistance, etc., and can block foreign substances such as moisture that may enter from the outside. In addition, the second urea coating layer 123, like the first urea coating layer 121, can prevent damage to or cracks in the insulation part.

The thickness of the second urea coating layer 123 is not particularly limited.

The second urea coating layer 123 may be formed by spraying a second urea coating composition on the outer surface of the first urea coating layer where the reinforcement layer is not formed and on the outer surface of the reinforcement layer, similar to the method of forming the first urea coating layer 121, but is not limited thereto. At this time, the second urea coating composition may be the same as or different from the first urea coating composition, and is not particularly limited as long as it is generally known in the art.

The reinforcement layer 122 is disposed in a partial region between the first urea coating layer 121 and the second urea coating layer 123, as shown in FIG. 1.

Specifically, as shown in FIG. 2, a reinforcement layer 122 is formed in a partial region between the first urea coating layer 121 and the second urea coating layer 123, and as shown in FIG. 3, the reinforcement layer 122 is not formed in the remaining region. The reinforcement layer 122 creates a gap between the first urea coating layer 121 and the second urea coating layer 123, thereby creating a gap between the insulation part 110 and the protection part 120, and can also reinforce the strength of the protection part 120. For this reason, when the insulation part 110 contracts due to the temperature of the liquefied gas accommodated inside the tank body T, the reinforcement layer 122 can play a role in compensating for the contraction amount, thereby preventing potential damage to the outer protection system.

In particular, when injecting or discharging liquefied gas into or out of the storage tank body T, the upper side of the storage tank body T experiences a greater temperature change than the lower side, and as a result, the upper side of the storage tank body T experiences greater displacement due to contraction and expansion than the lower side. Therefore, the upper region of the outer protection system 100 corresponding to the upper outer surface of the storage tank body T is more likely to be delaminated from the tank body T or to be displaced, damaged, or cracked compared to the lower region of the outer protection system corresponding to the lower outer surface. For this reason, in the present invention, as shown in FIG. 1, the reinforcement layer 122 is disposed in the region between the outer surface of the first urea coating layer 121 corresponding to the upper portion of the tank body T and the inner surface of the second urea coating layer 123.

According to an embodiment, the outer protection system 100 of the present invention includes an insulation part 110; and a protection part 120 disposed on the insulation part 110, wherein the protection part 120 includes a first protection part (hereinafter, ‘upper protection part’) 120A in which a first urea coating layer 121, a reinforcement layer 122, and a second urea coating layer 123 are sequentially laminated on an outer surface of the insulation part 110 corresponding to an upper region of the tank body T; and a second protection part (hereinafter, ‘lower protection part’) 120B in which a first urea coating layer 121 and a second urea coating layer 123 are sequentially laminated on an outer surface of the insulation part 110 corresponding to a remaining region of the tank body T (see FIGS. 2 and 3). Accordingly, the present invention can minimize delamination, damage, and displacement of the outer protection system caused by temperature changes in the upper portion of the storage-tank body T.

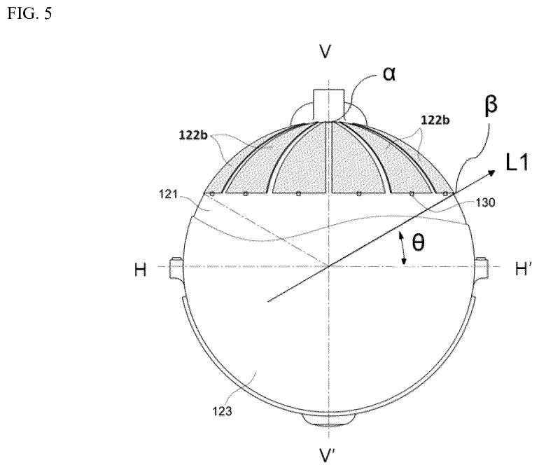

According to another embodiment, as shown in FIG. 5, the upper region of the storage tank body may be a region extending from a vertex (α) of the storage tank body, where the vertex (α) intersects the vertical center line (e.g., line of the short axis) (V-V′) of the storage tank body, to a point (β) of the storage tank body where a first line L1 intersects the storage tank body, wherein the first line L1 forms an angle of 15 to 45° (specifically, 20 to 40°, and more specifically 25 to 35°) with the horizontal center line (e.g., line of the long axis) (H-H′) of the storage tank body.

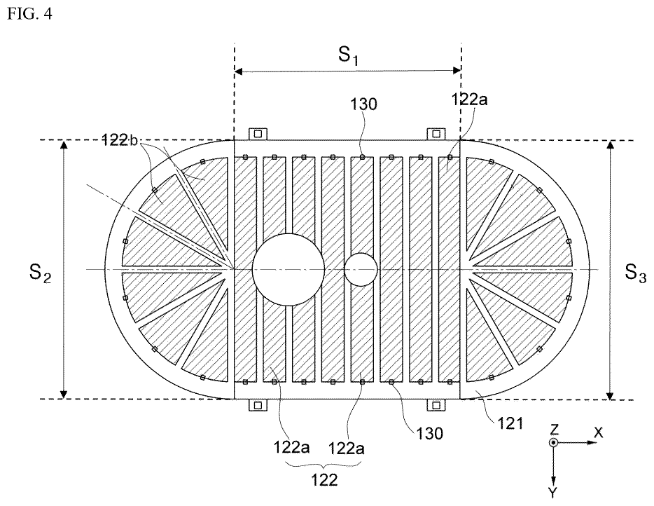

The aforementioned reinforcement layer 122 includes a plurality of reinforcements 122a, 122b, and the plurality of reinforcements 122a, 122b are spaced apart from each other (see FIGS. 4 and 5). Thus, the present invention can significantly reduce the occurrence of wrinkling on the surface of the outer protection system by separately disposing the reinforcement layer 122 in a plurality of compartments (i.e., a plurality of reinforcements), compared to the case where the reinforcement layer is formed as a single large area without sectionalization.

The arrangement method of the plurality of reinforcements and the shape of the reinforcements are adjusted according to the shape of the tank body T.

For example, when the shape of the tank body T as seen from the top is elliptical as shown in FIG. 4, in the central region (S1) of the tank body, elongated reinforcements 122a are arranged in parallel and spaced apart from each other in the width direction (Y-axis direction) of the tank body, and in the two side regions (S2, S3) of the tank body, fan-shaped reinforcements 122b are arranged along the circumferential direction and spaced apart from each other (see FIGS. 4 and 5).

As another example, when the shape of the tank body T viewed from the top is circular, fan-shaped reinforcements 122b can be arranged spaced apart from each other along the circumferential direction.

As yet another example, when the shape of the tank body T viewed from the top is rectangular, elongated reinforcements 122a in the longitudinal direction (X-axis direction) or the width direction (Y direction) of the tank body can be arranged in parallel and spaced apart from each other.

The reinforcement 122a, 122b usable in the present invention is not particularly limited as long as it has adhesion (adhesive strength) and can be easily attached to the first urea coating layer 121, and may be, for example, a rubber-containing composite sheet.

The rubber-containing composite sheet may be a composite sheet including a fiber sheet and/or a metal sheet together with rubber. The material of the fiber sheet may be glass fiber or carbon fiber, and the material of the metal sheet may be aluminum, iron, or stainless steel, but is not limited thereto.

The fiber sheets and metal sheets may be in a plate form or a mesh form. However, when the fiber sheet and metal sheet are in a mesh form, the flexibility of the reinforcement layer 122 itself is superior to when they are in a plate form, so that deformation of the first and second urea coating layers 121, 123 can be minimized.

According to an embodiment, the rubber-containing composite sheet may be a composite sheet containing: butyl rubber; and a fiber sheet or a metal sheet. Composite sheets containing butyl rubber not only have excellent initial adhesion, but their adhesion (adhesive strength) also gradually decreases over time. For this reason, when the reinforcement 122a, 122b is a butyl rubber-containing composite sheet, the reinforcement layer 122 may delaminate from the first urea coating layer 121 over time, forming a void (space). Moisture that penetrates from the outside or is generated internally may collect in these voids.

Accordingly, the outer protection system 100 according to the present invention may further include drain paths 130 respectively disposed between an inner surface of a lower portion of each reinforcement 122a, 122b and a corresponding outer surface of the first urea coating layer 121 in order to discharge moisture collected in the void formed inside the reinforcement layer 122 to the outside, as illustrated in FIG. 1. The plurality of drain paths 130 can discharge moisture that collects in the void formed when the reinforcement layer 122 is partially delaminated (separated) from the first urea coating layer 121 to the outside of the outer protection system.

The drain path 130 is a path for discharging moisture collected inside to the outside, and can be formed using a plate with excellent durability and corrosion resistance even in a marine environment. The plate may be a metal plate or a plastic plate, but is not limited thereto. According to an embodiment, the drain path 130 can be formed of a polyurea plate.

Specifically, after attaching a plate (e.g., a polyurea plate) on the outer surface of the first urea coating layer 121, a reinforcement layer 122 is formed, and then a second urea coating composition is sprayed and cured. At this time, the plate is integrated (combined) with the inner surface of the second urea coating layer 123 that is being cured, and at the same time, is delaminated from the outer surface of the first urea coating layer 121 and lifted. As a result, a void (gap) is created between the inner surface of the plate and the outer surface of the first urea coating layer 121. At this time, the void is formed in a shape like a hole penetrating the second urea coating layer 123 in the thickness direction. Accordingly, the void can become a drain path 130, which is a passage that discharges moisture that has collected in the void on the inner surface of the reinforcement 122a, 122b to the outside of the outer protection system. Thus, moisture that collects in the void inside the reinforcement 122a, 122b of the outer protection system can be easily discharged to the outside by gravity through the drain path 130.

Although not shown in the drawings, the protection part 120 may further include a UV blocking layer (not shown) disposed on the second urea coating layer 123. Since the UV blocking layer has excellent UV blocking properties, it can protect the second urea coating layer 123 from UV rays, and thus the durability of the outer protection system of the present invention can be improved.

The UV blocking layer can be formed by applying a UV blocking coating composition on the second urea coating layer 123. The UV-blocking coating composition is not particularly limited as long as it is a coating solution (paint) containing a UV-blocking agent generally known in the art. Examples of the UV-blocking agents include, but are not limited to, hindered amine-based, salicylic acid-based, benzophenone-based, benzotriazole-based, and cyanoacrylate-based UV-blocking agents.

The outer protection system for a liquefied gas storage tank according to the present invention described above can be applied not only to an onshore liquefied gas storage tank, but also to any marine structure used while floating on the sea where currents occur. In other words, the outer protection system for a liquefied gas storage tank according to the present invention can be applied not only to a liquefied gas carrier transporting LNG or LPG, or a ship such as an LNG RV (LNG Regasification Vessel), but also to offshore plants such as an LNG FPSO (Floating, Production, Storage and Offloading) or an LNG FSRU (Floating Storage and Regasification Unit).

Meanwhile, the outer protection system for a liquefied gas storage tank according to the present invention can be formed through various methods. However, the strength of the reinforcement part can be further increased by forming the reinforcement part based on two urea coating layers and forming a reinforcement layer by arranging a plurality of reinforcements spaced apart in a partial region between the two urea coating layers.

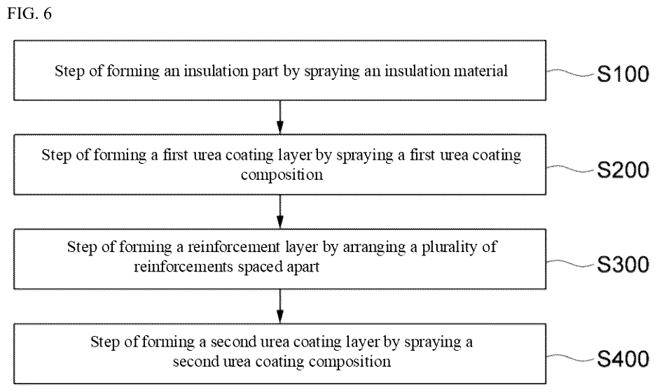

FIG. 6 is a flowchart illustrating an outer protection system for a liquefied gas storage tank according to the present invention.

For example, as illustrated in FIG. 6, the outer protection system for a liquefied gas storage tank according to the present invention can be formed by a method comprising the steps of: (S100) forming an insulation part on the outer surface of a storage tank body accommodating liquefied gas; (S200) spraying a first urea coating composition on the outer surface of the insulation part to form a first urea coating layer; (S300) disposing a reinforcement layer by arranging a plurality of reinforcements spaced apart from each other on a part of the outer surface of the first urea coating layer; and (S400) forming a second urea coating layer by spraying a second urea coating composition on the outer surface of the first urea coating layer where the reinforcement layer is not formed and on the outer surface of the reinforcement layer. However, the method is not limited to the above steps, and it is not required that each step be performed sequentially, but the steps of each process may be modified or selectively combined and performed according to the design specifications.

Hereinafter, with reference to FIG. 6, a method for forming an outer protection system for a liquefied gas storage tank according to the present invention will be described step by step. To avoid redundancy, descriptions of elements already described are omitted.

### (S100) Step: Forming the Insulation Part

An insulation part 110 is formed on the outer surface of the storage tank body T that accommodates liquefied gas.

According to an embodiment, step (S100) can form an insulation part 110 integrally attached to the storage tank body T by directly and continuously spraying an insulation material on the outside of the tank body T. Thus, when the insulation part 110 is formed by directly spraying the insulation material on the outer surface of the tank body T, heat loss can be prevented more reliably because there are no connecting parts or a reduced number thereof compared to the case of attaching an insulation material pre-fabricated in the form of a panel to the outer surface of the tank body T.

If necessary, the insulation part 110 formed on the outside of the tank body T may be formed by being divided into multiple compartments. Further, the insulation material can be sprayed and laminated multiple times to form the insulation part 110 as multiple layers. At this time, the density of each layer can be adjusted to be the same or different.

The insulation material usable in the present invention is not particularly limited as long as it is a composition for forming polyurethane foam generally known in the art.

Meanwhile, as described above, instead of spraying the insulation material (e.g., a composition for forming polyurethane foam), a panel-shaped insulation material (e.g., a polyurethane foam panel) may be attached to the outside of the tank body T. However, when attaching the insulation material, there is a disadvantage in that, compared to spray coating the insulation material, an additional process of adding another insulation material between each insulation material or connecting them with a connection part must be performed.

Although not shown, before performing the following step (S200), an additional step of polishing the surface of the formed insulation part 110 may be performed.

The polishing step can remove scratches from the insulation part 110, smooth its surface, and uniformly adjust the thickness of the insulation part 110.

This polishing step can be performed through a method known in the art, for example by sanding treatment.

### (S200) Step: Forming the First Urea Coating Layer

As shown in FIG. 6, a first urea coating composition is sprayed on the outer surface of the insulation part 110 formed in step (S100) to form a first urea coating layer 121.

This step, similar to step (S100) described above, can form a first urea coating layer 121 integrally attached to the outer surface of the insulation part 110 by directly and continuously spraying the first urea coating composition onto the outer surface of the insulation part 110. In addition, the first urea coating composition may be sprayed and laminated multiple times to form the first urea coating layer 121 as multiple layers.

### (S300) Step: Forming the Reinforcement Layer

A reinforcement layer is formed by arranging a plurality of reinforcements 122a, 122b spaced apart on a part of the outer surface of the first urea coating layer 121 formed in step (S200).

According to an embodiment, in step (S300) a plurality of reinforcements 122a, 122b may be arranged spaced apart from each other on the outer surface of the first urea coating layer 121 corresponding to the upper portion of the tank body T.

At this time, the plurality of reinforcements 122a, 122b have adhesion and can be easily attached to the first urea coating layer 121.

### (S400) Step: Forming the Second Urea Coating Layer

A second urea coating composition is sprayed on the exposed surface of the first urea coating layer 121 formed in step (S200) and the exposed surface of the reinforcement layer 122 formed in step (S300) to form a second urea coating layer.

In this step, similar to step (S200) described above, a second urea coating composition is directly and continuously sprayed on the outer surface of the first urea coating layer 121 where the reinforcement layer 122 is not formed and on the outer surface of the reinforcement layer 122, thereby forming a second urea coating layer 123 integrally attached to the first urea coating layer 121 and the reinforcement layer 122. In addition, the second urea coating composition may be sprayed and laminated multiple times to form the second urea coating layer 123 as multiple layers.

### (S500) Step: Forming the UV Blocking Layer

Optionally, a step of forming a UV blocking layer on the second urea coating layer 123 formed in the step (S400) using a UV blocking coating composition may be further included.

### (S600) Step: Forming the Drain Path

Optionally, after the step (S200) and before performing step (S300), a step of disposing drain paths respectively on the outer surface of the first urea coating layer 121 corresponding to a lower portion of each reinforcement 122a, 122b may be further included. The plurality of drain paths can each discharge moisture that has collected in the voids of the reinforcement layer within the outer protection system to the outside of the outer protection system.

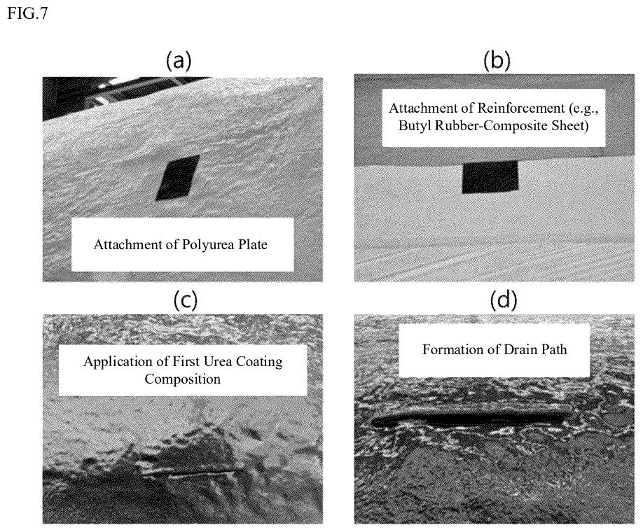

Specifically, as illustrated in FIG. 7, the drain path 130 is formed by attaching a plate (e.g., a polyurea plate) to the outer surface of the first urea coating layer 121 at positions corresponding to the lower side of each reinforcement to be arranged at a predetermined position. Thereafter, as described in the step (S300), each reinforcement is arranged spaced apart at a preset position to form the reinforcement layer 122. Next, step (S400) is performed to spray the second urea coating composition onto the exposed surfaces of the first urea coating layer 121 and the reinforcement layer 122 and cure them. At this time, the plate attached to the outer surface of the first urea coating layer 121 is integrated (merged) with the inner surface of the second urea coating layer 123 that is being cured, and at the same time, the plate is delaminated from the outer surface of the first urea coating layer 121 and lifted. As a result, a void (gap) is created between the inner surface of the plate and the outer surface of the first urea coating layer 121. This void is formed in a shape like a hole penetrating the second urea coating layer 123 in the thickness direction, as shown in FIG. 7(c). Thus, the void can form a drain path 130, which is a passage that discharges moisture that has collected on the inner surface of the reinforcement 122a, 122b to the outside of the outer protection system.

In addition, in the present invention, when forming the drain path 130, the upper outer surface of the plate can be in contact (attached) with the lower inner surface of the reinforcement 122a, 122b, while only the left and right ends of the plate are attached to the outer surface of the first urea coating layer 121. Accordingly, the drain pass 130 has a discharge port formed on the lower side of the drain pass 130, and thus moisture that is condensed in the empty space can be easily discharged to the outside by gravity.

### <Liquefied Gas Storage Tank>

The present invention provides a liquefied gas storage tank comprising the aforementioned outer protection system.

Specifically, a liquefied gas storage tank according to the present invention includes a storage tank body T for accommodating liquefied gas; and the outer protection system for a liquefied gas storage tank described above disposed on the outer surface of the storage tank body T (see FIG. 1). To avoid redundancy, descriptions of elements already described are omitted.

In the present invention, the storage tank body T can store liquefied gas in a high-pressure, cryogenic state. For this reason, the body T of the liquefied gas storage tank has a simple structure and also has a structure that maintains strong impact resistance and liquid-tightness. In particular, the storage tank body T can be provided with a structure capable of withstanding internal pressure generated by vaporization of the liquefied gas accommodated therein. For example, the storage tank body T may be provided as a pressure vessel.

In addition, the storage tank body T has an inner surface that comes into direct contact with the cryogenic liquefied gas. For this reason, the material of the storage-tank body T may be a metal material having excellent low-temperature properties, such as steel, stainless steel, nickel alloy steel, aluminum alloy, or high-Mn steel, but is not limited thereto.

In addition, the shape of the cross-section of the storage tank body T perpendicular to the longitudinal direction may be a circle, an ellipse, or a polygon, and the outer surface may be a curved surface or a flat surface. Accordingly, the inner surface of the outer protection system 100 may be curved or flat.

Hereinafter, the present invention will be described in detail through embodiments, but the following embodiments and experimental embodiments are merely illustrative of one form of the present invention, and the scope of the present invention is not limited thereto.

### Embodiment 1

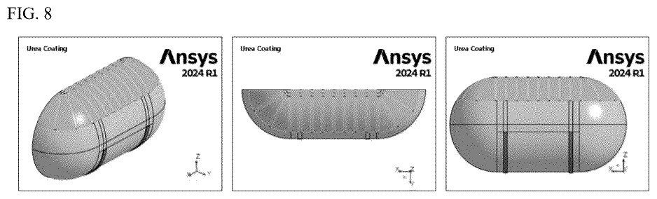

A polyurethane foam composition was sprayed onto the outer surface of a storage tank body accommodating liquefied gas inside, and cured to form an insulation part made of polyurethane foam. Afterwards, the surface of the insulation part was sanded. Next, a first urea coating composition was sprayed onto the outer surface of the insulation part and cured to form a first urea coating layer. Thereafter, a polyurea plate was attached on the outer surface of the first urea coating layer corresponding to the lower position of each reinforcement to be placed in the preset position. Afterwards, each reinforcement was spaced apart at a preset location to form the reinforcement layer 122. At this time, as shown in FIG. 8, a plurality of reinforcements having a long shape were arranged spaced apart from each other in an area corresponding to the central portion of the tank body, and a plurality of reinforcements having a fan shape (central angle (θ): approximately 30°) were arranged spaced apart from each other in an area corresponding to both side portions of the tank body. Thereafter, a second urea coating composition was sprayed on the exposed surface of the first urea coating layer and the exposed surface of the reinforcement layer 122 and cured. At this time, the polyurea plate attached to the outer surface of the first urea coating layer is combined with the inner surface of the second urea coating layer that is being cured, and at the same time, the polyurea plate is delaminated from the outer surface of the first urea coating layer, and a lifted void is created in the shape of a hole that penetrates the second urea coating layer in the thickness direction, thereby forming a drain path 130 that is a passage for discharging moisture that collects on the inner surface of the reinforcement 122a, 122b to the outside of the outer protection system. Thereafter, a liquefied gas storage tank having an outer protection system was manufactured by painting UV blocking paint on the outer surface of the second urea coating layer.

### Embodiment 2

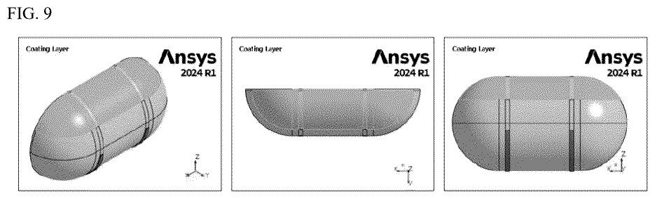

As shown in FIG. 9, except that a large-area rectangular reinforcement was placed in the area corresponding to the central portion of the tank body, and reinforcements having a fan shape (central angle (θ): 180°) were respectively placed in the areas corresponding to the two side portions of the tank body, a liquefied gas storage tank having an outer protection system was manufactured in the same manner as in Embodiment 1.

### Experimental Embodiment 1

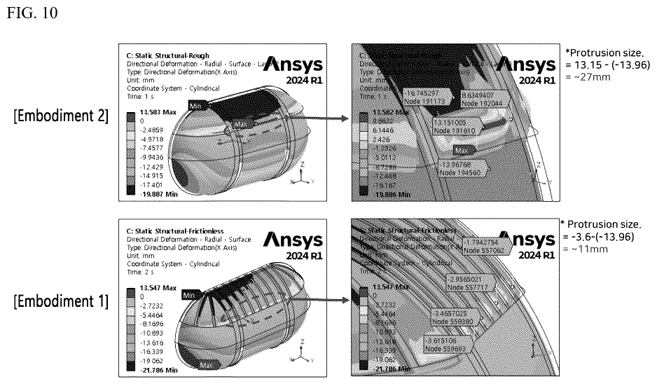

In order to confirm the thermal stability of the outer protection system for a liquefied gas storage tank according to the present invention, a test was conducted as follows, and the results are shown in FIG. 10.

As can be seen in FIG. 10, the liquefied gas storage tank of Embodiment 1 showed a relatively large reduction in surface wrinkling compared to the liquefied gas storage tank of Embodiment 2. In addition, the size of bubbles formed on the surface of the liquefied gas storage tank of Embodiment 1 was about 11 mm, while the size of bubbles formed on the surface of the liquefied gas storage tank of Embodiment 2 was about 27 mm.

Thus, it was found that the outer protection system for a liquefied gas storage tank according to the present invention has excellent thermal stability.

Although the present invention has been illustrated and described in connection with exemplary embodiments for illustrating the principles of the present disclosure, the present invention is not limited to the configuration and operation as illustrated and described as such. Rather, it will be apparent to those skilled in the art that many changes and modifications may be made to the present invention without departing from the spirit and scope of the appended claims.

What is claimed is:

1. An outer protection system for a liquefied gas storage tank, comprising: an insulation part disposed on an outer surface of a storage tank body accommodating liquefied gas therein; and a protection part disposed on an outer surface of the insulation part; wherein the protection part includes:
a first urea coating layer disposed on the insulation part;
a second urea coating layer disposed on the first urea coating layer; and a reinforcement layer disposed in a partial region between the first urea coating layer and the second urea coating layer and including a plurality of reinforcements spaced apart from each other.

2. The outer protection system for a liquefied gas storage tank of claim 1, wherein the reinforcement layer is disposed only in a region between the outer surface of the first urea coating layer and the inner surface of the second urea coating layer corresponding to an upper region of the storage tank body.

3. The outer protection system for a liquefied gas storage tank of claim 1, wherein the reinforcement comprises a rubber-containing composite sheet.

4. The outer protection system for a liquefied gas storage tank of claim 3, wherein the rubber-containing composite sheet is a composite sheet containing: butyl rubber; and a fiber sheet or a metal sheet.

5. The outer protection system for a liquefied gas storage tank of claim 1, wherein the protection part further comprises a UV blocking layer disposed on the second urea coating layer.

6. The outer protection system for a liquefied gas storage tank of claim 1,
further comprising drain paths respectively disposed between an inner surface of a lower portion of each of the reinforcements and a corresponding outer surface of the first urea coating layer.

7. The outer protection system for a liquefied gas storage tank of claim 6, wherein the drain path is formed using a plate.

8. A liquefied gas storage tank, comprising:
a storage tank body accommodating liquefied gas; and the outer protection system for a liquefied gas storage tank of claim 1, disposed on an outer surface of the storage tank body,
wherein the outer protection system for a liquefied gas storage tank, comprising:
an insulation part disposed on an outer surface of a storage tank body accommodating liquefied gas therein; and
a protection part disposed on an outer surface of the insulation part;
wherein the protection part includes:
a first urea coating layer disposed on the insulation part;
a second urea coating layer disposed on the first urea coating layer; and
a reinforcement layer disposed in a partial region between the first urea coating layer and the second urea coating layer and including a plurality of reinforcements spaced apart from each other.

9. The liquefied gas storage tank of claim 8, wherein the reinforcement layer is disposed only in a region between the outer surface of the first urea coating layer and the inner surface of the second urea coating layer corresponding to an upper region of the storage tank body.

10. The liquefied gas storage tank of claim 8, wherein the reinforcement comprises a rubber-containing composite sheet.

11. The liquefied gas storage tank of claim 10, wherein the rubber-containing composite sheet is a composite sheet containing: butyl rubber; and a fiber sheet or a metal sheet.

12. The liquefied gas storage tank of claim 8, wherein the protection part further comprises a UV blocking layer disposed on the second urea coating layer.

13. The liquefied gas storage tank of claim 8, wherein the outer protection system for a liquefied gas storage tank further comprises drain paths respectively disposed between an inner surface of a lower portion of each of the reinforcements and a corresponding outer surface of the first urea coating layer.

14. The liquefied gas storage tank of claim 13, wherein the drain path is formed using a plate.

15. A method for forming an outer protection system for a liquefied gas storage tank, the method comprising: a step of forming an insulation part by spraying an insulation material onto an outer surface of a storage tank body accommodating liquefied gas;
a step of forming a first urea coating layer by spraying a first urea coating composition onto an outer surface of the insulation part;
a step of forming a reinforcement layer by arranging a plurality of reinforcements spaced apart from each other on a part of an outer surface of the first urea coating layer; and
a step of forming a second urea coating layer by spraying a second urea coating composition onto the outer surface of the first urea coating layer where the reinforcement layer is not formed and an outer surface of the reinforcement layer.

16. The method for forming an outer protection system for a liquefied gas storage tank of claim 15, further comprising:
forming a UV blocking layer on the second urea coating layer using a UV blocking coating composition.

17. The method for forming an outer protection system for a liquefied gas storage tank of claim 15, further comprising,
before the step of forming the reinforcement layer:
a step of disposing drain paths respectively on the outer surface of the first urea coating layer corresponding to a lower portion of each of the reinforcements.
